(19) United States
(12) Patent Application Publication
(10) Pub. No.: US 2007/0266748 A1
(43) Pub. Date: Nov. 22, 2007

(54) Electronic Key

(75) Inventors: Hartmut Fitz, Urbach (DE); Michael Geber, Aichwald (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 10/582,477

(22) PCT Filed: Dec. 4, 2004
(86) PCT No.: PCT/EP04/13799

§ 371 Date: Apr. 19, 2007

(30) Foreign Application Priority Data
Dec. 11, 2003 (DE) 103 57 931.1

(51) Int. Cl. E05B 19/00

(52) U.S. Cl. 70/395

(57) ABSTRACT

An electronic key includes a key housing that has a suspension eyelet near its periphery, with the suspension eyelet having a deployed use position and a stowed non-use position. The suspension eyelet is held by a guide arm which is movable such that the suspension eyelet is lowered into a receiving space in the key housing where it is inaccessible in its non-use positional. It can also be moved out into the use position for the purpose of suspending the electronic key.

The invention relates to an electronic key of the type mentioned in the preamble of claim 1.

An electronic key of this type is already known from DE 198 20 831 C1 as a remote control means for a motor car locking system. The remote control means is accommodated in a plastic key housing which has a receiving shaft for a flat mechanical key, it being possible to insert the flat key into the receiving shaft and completely withdraw it from the latter via an insert opening on the narrow side of the key housing. The inserted flat key is secured in the receiving shaft by means of a locking slide which completely covers the insert opening in its securing position and can be moved into a position which releases the insert opening in order to withdraw the flat key.

The grip section of the flat key is provided with a suspension hole which, with the flat key inserted, is accessible via a cutout in the key housing for the purpose of suspending the key. Some regions of the cutout which are arranged in the edge region of the key housing are bounded by the locking slide, so that the flat key can also be withdrawn from the receiving shaft in the release position of the locking slide when a keyring is attached to its suspension hole. After the flat key is withdrawn, the locking slide can move back to its locking position, with the locking slide together with the wall regions of the key housing which bound the cutout forming a suspension eyelet which allows the key housing to be suspended even with the flat key withdrawn. The suspension eyelet can therefore be moved from a non-use position with the locking slide open into its peripherally closed use position by locking the slide in the manner of a carabiner closure.

Since the suspension hole in the inserted flat key has to be accessible via the opening in the suspension eyelet, the structural freedom of movement when designing the suspension eyelet is relatively limited.

The object of the invention is to improve an electronic key of the type mentioned in the preamble of claim 1 to the effect that the structural freedom of movement when designing the suspension eyelet is considerably increased.

According to the invention, this object is achieved by the features of claim 1.

Further features which advantageously define the invention can be found in the subclaims.

The advantage achieved by the invention involves the suspension eyelet having a cross section of virtually any desired shape, particularly a peripherally closed cross section, since the suspension eyelet is lowered into a receiving space in the key housing so that it is inaccessible in its non-use position, and can be moved out into the use position by means of a guide arm for the purpose of suspending said key housing.

The suspension eyelet can be held on the key housing by means of the guide arm such that it can pivot or slide as a function of the installation space available in the key housing.

The key housing can have a receiving shaft for an associated mechanical key which can be inserted into the receiving shaft and completely withdrawn from the latter, with the suspension eyelet being provided for the purpose of suspending the key housing with the mechanical key withdrawn and being automatically moved to its use position when the mechanical key is withdrawn from the receiving shaft for the purpose of particularly simple operator control. In order to further simplify operator control of the electronic key, the mechanical key may force the suspension eyelet back into its non-use position when said mechanical key is inserted into the receiving shaft.

The suspension eyelet may be automatically moved to its use position in a particularly simple and reliable manner by means of a spring which is arranged on the key housing. In order to secure the suspension eyelet against the spring force in a particularly simple and reliable manner, said suspension eyelet, in its non-use position, may in this case be supported against a holding zone of the inserted mechanical key which is secured in the key housing by means of associated holding means.

In its use position, the suspension eyelet may be supported against a bearing point of the key housing under the action of the spring, and therefore be fixed in a play-free manner without rattling.

In order to allow a particularly space-saving construction, the mechanical key provided may be a flat key, with the suspension eyelet having a plate-like region which runs largely parallel to a broad side of the inserted flat key in a common receiving shaft of the key housing.

Exemplary embodiments of the invention are explained in greater detail below with reference to a drawing, in which

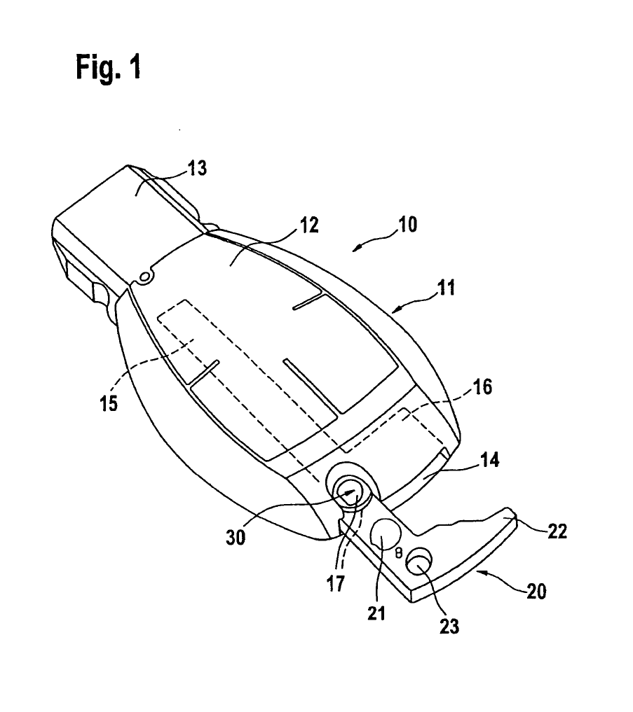

FIG. 1 shows a perspective, oblique view of an electronic key with an associated flat key,

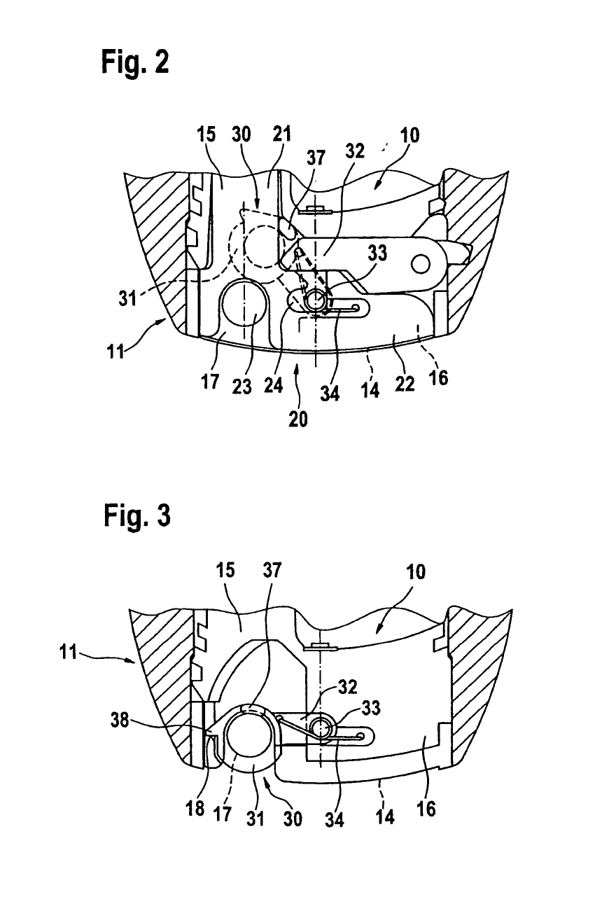

FIG. 2 shows a section through a key housing of the electronic key with the flat key inserted,

FIG. 3 shows a section through the key housing from FIG. 2 with the flat key withdrawn,

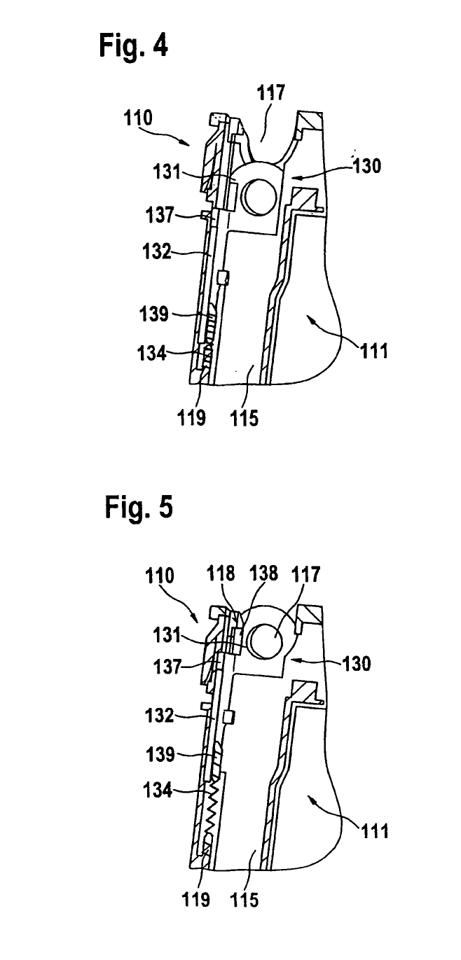

FIG. 4 shows an alternative embodiment of a key housing for an electronic key with a suspension eyelet in its non-use position, and

FIG. 5 shows the key housing from FIG. 4 with the suspension eyelet in its use position.

FIG. 1 shows an electronic key 10 with a key housing 11 which accommodates the electronic components, which are known per se, for radio remote control and for electronically identifying a motor car locking system.

The key housing 11 which is composed of plastic material comprises a grip section which has an operator control area 12 with three operator control switches arranged on its upper broad side, and a narrow shaft section 13 which can be inserted into an associated opening in an electronic ignition lock.

The narrow side of the grip section of the key housing 11, which narrow side is opposite the shaft section 13, is provided with a slot-like insert opening 14 through which a flat mechanical key 20 passes. The flat key 20 is shown in FIG. 1 in an intermediate position partially withdrawn from the receiving means of the key housing 11.

The flat key 20 which is usually produced from metal is L-shaped and comprises a shaft section 21, which is provided with a control path, and a grip leg 22 which protrudes laterally from the upper end of the shaft section 21. The grip leg 22 is provided with a circular fastening hole 23 for the purpose of suspending the flat key 20 from a keyring, for example. The flat key 20 can be inserted into a receiving means of the key housing 11 and completely withdrawn from the latter via the insert opening 14, said receiving means comprising a narrow receiving shaft 15 for the shaft section 21 and an adjoining widened receiving opening 16 for the grip leg 22 of the flat key 20. In order to also enable the flat key 20 to be inserted when a keyring is fitted in the fastening hole 23, the key housing 11 has cutouts 17 at its two mutually opposite broad sides, these cutouts extending as far as the upper peripheral side of said key housing.

FIG. 2 shows that, in its inserted position, the flat key 20 is almost completely lowered into the receiving means of the key housing 11, with the fastening hole 23 of the flat key 20 being positioned in the region of overlap with the cutouts 17 of the key housing 11, and therefore being accessible from two sides. A fastening means, for example a hook or a keyring, can therefore pass through the fastening hole 23 of the inserted flat key 20 for the purpose of suspending the electronic key 10.

The shaft section 21 of the inserted flat key 20 is completely lowered into the receiving shaft 15 and close to its lower end bears against an opposite first bearing point of the key housing 11, whereas a narrow side of its grip leg 22 is supported against an opposite second bearing point of the key housing 11, which second bearing point is diagonally opposite the first bearing point as seen along the receiving shaft 15. The third bearing point for supporting the flat key 20 is formed by a spring-mounted blocking element (not shown) whose support end is supported in a recess 24 in the lower face of the grip leg 22.

The blocking element is mounted on the key housing 11 such that it can slide, with the advancing direction of the blocking element running approximately perpendicular to the insert direction of the flat key 22. In its securing position, the blocking element, which is made to slide in the direction of the recess 24 in the flat key 20 by a spring (not shown), is supported in the recess 24. The inserted flat key 20 is held in the receiving shaft 15 of the key housing 11 by means of the blocking element largely without play.

In order to be able to remove the flat key 22 from the key housing 11, the blocking element can be pulled back into a release position against the spring force by means of an operating slide (not shown), in which release position its support end is moved out such that it no longer coincides with the recess 24, so that the flat key 20 on a keyring which is attached in the fastening hole 23 can be removed from the key housing 11 counter to the insert direction.

In order to allow the flat key 20, which is virtually completely lowered into the key housing 11, to also be withdrawn without a keyring which penetrates the fastening hole 23, the flat key 20 may be pushed out into an intermediate position by a mold draft of the recess 24 which interacts with the blocking element, in which intermediate position the flat key 20 is pushed out of the receiving opening 14 in the key housing 11 by a length of several millimeters so that it can be gripped.

In order to allow the electronic key 10 to also be suspended with the flat key 20 completely withdrawn, a suspension eyelet 30 is arranged on the key housing 11, held in the region of overlap with the cutouts 17 in the key housing 11 in its use position, and lowered into the receiving shaft 15 so that it is inaccessible in its non-use position. The plate-like suspension eyelet 30 is arranged close to the insert opening 14 in the receiving shaft 15 of the key housing 11 and runs with its broad sides largely parallel and at a very small distance from the adjacent broad sides of the inserted flat key 20. The suspension eyelet 30 is integrally formed from sheet metal and comprises a circular, peripherally closed fastening ring 31 which is fastened to the key housing 11 by means of a radially protruding lever arm 32 and an associated pin 33 such that it can pivot, with the pivot axis running perpendicular to the longitudinal center plane of the plate-like suspension eyelet 30.

A torsion spring 34, which is composed of spring wire and bears against a support point of the key housing 11 with its first leg and is supported on the periphery of the fastening ring 31 with its second leg, is wound around the pin 33.

In the non-use position of the suspension eyelet 30 which is shown in FIG. 2, its lever arm 32 projects into the receiving shaft 15 of the key housing 11 obliquely to the insert direction of the flat key 20, with the fastening ring 31 being lowered into the receiving shaft 15 outside the region of overlap with the cutouts 17 and therefore being inaccessible and invisible from the outside. In this case, the suspension eyelet 20 is pivoted in the direction of the insert opening 14 by the prestressed torsion spring 34 and supported against a lateral narrow side of the flat key 20 counter to the spring force by means of a holding pin 37 which protrudes from the fastening ring 31. In this case, the outer periphery of the fastening ring 31 in the region of the holding pin 37 bears linearly against an opposite wall region of the key housing 11.

The suspension eyelet 30 is therefore held in its non-use position against the force of the prestressed torsion spring 34 by means of the holding pin 37 and the inserted flat key 20. After the blocking element is unlocked, the flat key 20 can be withdrawn from the receiving shaft 15 of the key housing 11, with the suspension eyelet 30 which is acted on by the torsion spring 34 following the flat key 20 in the withdrawal direction and automatically being pivoted until it reaches its use position.

FIG. 3 illustrates the suspension eyelet 30 in its use position with the flat key 20 completely withdrawn from the receiving shaft 15. In this case, the suspension eyelet 30 is positioned with its fastening ring 31 in the region of overlap with the cutouts 17 in the key housing 20, as a result of which the opening in the fastening ring 31 is accessible from two sides and therefore a holding means, for example a hook or a keyring, can pass through said opening in the fastening ring for the purpose of suspending the electronic key 10.

The suspension eyelet 30 has a holding lug 38 which protrudes radially from the outer periphery of its fastening ring 31 and is supported against an opposite bearing face 18 of the key housing 11 in the use position. In this case, the torsion spring 34 is not yet fully relieved of stress even in the use position, but instead presses the suspension eyelet 20 against the bearing face 18 of the key housing 11 with a physically prespecified prestress, so that the suspension eyelet 30 is securely fixed in its use position in a play-free manner without rattling.

When the flat key 20 is reinserted into the receiving shaft 15 of the key housing 11, a lateral narrow side of the shaft section 21 of said flat key runs from a physically prespecified insert depth onto the holding pin 37 of the suspension eyelet 30 and forces the suspension eyelet 30 back into its lowered non-use position as said flat key is inserted further.

FIG. 4 and FIG. 5 illustrate an alternative embodiment of an electronic key 110 which differs from the electronic key 10 only on account of a key housing 111 with a suspension eyelet 130 of alternative design.

Only one region of the key housing 111 with a receiving shaft 115 for an associated flat key (not shown) is shown here, it being possible to insert the flat key into the receiving shaft 115 and completely withdraw it from the latter via an insert opening in the upper narrow side of the key housing 111. A suspension eyelet 130 is arranged in the upper end section of the receiving shaft 115 and is integrally formed as a bent sheet-metal part. The suspension eyelet 130 comprises a plate-like fastening ring 131 whose broad sides run parallel to the adjacent broad side of the inserted flat key and which is held at a very small distance from the latter. A bar-like guide leg 132 is bent away from the circular, peripherally closed fastening ring 131 in a perpendicular manner and the suspension eyelet 130 is guided in the receiving shaft 115 in a sliding manner parallel to the insert direction of the flat key by means of said guide leg.

In its non-use position which is shown in FIG. 4, the suspension eyelet 131 is arranged in the receiving shaft 115 outside the region of overlap with the cutouts 117 in the key housing 111 and is therefore inaccessible and invisible from the outside. The guide leg 132 runs largely parallel to a lateral narrow side of the inserted flat key in the receiving shaft 115 of the key housing 111 and, with one of its broad sides, bears against a wall of the key housing 111 which is laterally adjacent to the receiving shaft 115. The guide leg 132 has a protruding guide lug 137 close to its upper end, this guide lug engaging with an exact fit into a guide groove (not shown) in the key housing 111 for the purpose of guiding the suspension eyelet 130 in a sliding manner.

At its free end, the guide leg 132 of the suspension eyelet 130 is spread out in the manner of a fork into two holding arms and a fastening mandrel 139 which runs between the latter, with an upper end section of a helical spring 134 being pushed onto the latter. The opposite lower end region of the helical spring 134 is pushed onto a fastening mandrel 119 of the key housing 111, this fastening mandrel being situated at a distance opposite the fastening mandrel 139 of the guide leg 132.

In its non-use position, the suspension eyelet 130 is acted on by the prestressed helical spring 134 in the withdrawal direction of the flat key and is supported with the upper narrow side 137 of its guide leg 132 against an edge which projects laterally from the opposite narrow side of the flat key. The suspension eyelet 130 is therefore held down in its lowered position against the spring force of the helical spring 134 by means of the inserted flat key, with the inserted flat key being secured in the receiving shaft 115 of the key housing 111 in a similar manner to the flat key 20 by means of a blocking element (not shown), and it being possible to completely withdraw said flat key from the receiving shaft 115 of the key housing 111 through the insert opening after the blocking element is unlocked.

When the flat key is withdrawn, the suspension eyelet 130 is automatically moved along with the flat key in the withdrawal direction by the prestressed helical spring 134 until said suspension eyelet reaches its raised use position.

FIG. 5 shows that the fastening ring 131 of the suspension eyelet 130 has a holding lug 138 which protrudes radially outward and, in the use position, has run onto an opposite bearing face 118 of the key housing 111. In this case, the holding lug 138 is pressed against the bearing face 118 by the helical spring 134, which is not yet fully relieved of stress even in the use position, by a physically prespecified prestress, as a result of which the suspension eyelet 130 is guaranteed to be fixed in a play-free manner without rattling.

In the use position, the fastening ring 131 of the suspension eyelet 130 is positioned in the region of overlap with the cutouts 117 in the key housing 111 and is therefore accessible for the purpose of suspending the electronic key 110 with the flat key withdrawn. When the flat key is inserted into the receiving shaft 115, the projecting edge of its narrow side runs onto the upper narrow side of the guide leg 117 of the suspension eyelet 130 and moves the suspension eyelet 130 under the prestress of the helical spring 134 until said suspension eyelet reaches its lowered non-use position.

1.-9. (canceled)

10. An electronic key having key housing that has a suspension eyelet in a region close to its periphery, the suspension eyelet having a deployed use and a stowed non-use position, wherein:
the suspension eyelet is held by a guide arm which is mounted to the housing;
the guide arm is movable such that the suspension eyelet is lowered into a receiving space in the key housing, in which it is inaccessible in its non-use position; and
the suspension eyelet is movable out into the use position for the purpose of suspending the electronic key.

11. The electronic key as claimed in claim 10, wherein the guide arm of the suspension eyelet is held on the key housing by means of a rotary bearing, such that it can pivot.

12. The electronic key as claimed in claim 10, wherein in that the guide arm of the suspension eyelet is held on the key housing such that it can slide.

13. The electronic key as claimed in claim 10, wherein:
the key housing has a receiving shaft for an associated mechanical key which can be inserted into the receiving shaft and can be completely withdrawn from the latter; and
the suspension eyelet is automatically moved into the use position when the mechanical key is withdrawn from the receiving shaft.

14. The electronic key as claimed in claim 13, wherein the mechanical key forces the suspension eyelet into its non-use position when the mechanical key is inserted into the receiving shaft.

15. The electronic key as claimed in claim 13, further comprising a spring arranged on the key housing; wherein said spring automatically moves the suspension eyelet into the use position.

16. The electronic key as claimed in claim 15, wherein, in its non-use position, the suspension eyelet is supported against a holding zone of the inserted mechanical key which is secured on the key housing by means of associated holding means.

17. The electronic key as claimed in claim 15, wherein, in the use position, the suspension eyelet is supported against a bearing point of the key housing under action of the spring.

18. The electronic key as claimed in claim 13, wherein:
the mechanical key is a flat key;
the suspension eyelet has a plate-like region which runs substantially parallel to a broad side of the inserted flat key in a common receiving shaft of the key housing.

19. An electronic key, comprising:
a key housing; and
a suspension eyelet by which the key housing can be supported on one of a key ring and a key hook;
wherein the suspension eyelet is movable between a deployed position in which it is accessible for such a key ring or hook, and a stowed position in which it is inaccessible for such a key ring or hook.

20. An electronic key, according to claim 10, wherein:
said housing further comprises a receptacle for accommodating insertion of an associated mechanical key for storage therein;
insertion of said mechanical key causes said supervision eyelet to be moved into the stowed position.

21. An electronic key, according to claim 20, wherein said mechanical key has a suspension structure by which the electronic key can be suspended when the suspension eyelet is in the stowed position.

22. An electronic key, according to claim 19, wherein:
the suspension eyelet is disposed on a guide arm; and
the guide arm includes a structure which is engageable with a corresponding structure of the mechanical key such that insertion of the mechanical key into the receptacle causes movement of the guide arm.

23. An electronic key, according to claim 22, wherein said movement of the guide arm comprises one of sliding and pivoting into the stowed position of the suspension eyelet.
